(19) United States
(12) Patent Application Publication
(10) Pub. No.: US 2013/0011928 A1
(43) Pub. Date: Jan. 10, 2013

(54) OPTICAL DETECTION SYSTEM AND/OR METHOD

(75) Inventor: Songping Gao, Ashland, MA (US)

(73) Assignee: ANALOGIC CORPORATION, Peabody, MA (US)

(21) Appl. No.: 13/636,358

(22) PCT Filed: Mar. 29, 2010
(86) PCT No.: PCT/US10/29030

§ 371 Date: Sep. 21, 2012

(51) Int. Cl. G01N 21/64; G01N 21/01

(52) U.S. Cl. 436/94; 250/458.1; 250/459.1; 250/453.11; 422/69; 250/216

(57) ABSTRACT

An optical detection system (100) includes an optical element (116, 202, 502) that directs emission radiation (108), which traverses away from an optical collection path (122), to the path, wherein the emission radiation is emitted by a radiation sensitive material in a sample (204) under study in response to the material absorbing excitation radiation, and the emission radiation has a spectral characteristic that corresponds to the material.

### TECHNICAL FIELD

The following generally relates to optical detection systems and/or methods.

### BACKGROUND

An optical detector has been configured for detection of electromagnetic radiation corresponding to the visible range of the electromagnetic spectrum and for generation of a signal indicative of spectral characteristics (e.g., wavelength, frequency or energy) of the detected electromagnetic radiation. In one application, such an optical detector has been employed in an optical detection system that includes an excitation source of electromagnetic radiation that generates and directs electromagnetic radiation, having known spectral characteristics, at a sample having one or more components of interest, each labeled with a different radiation sensitive label, such as different fluorescence. The labels absorb radiation incident thereon and, in response, emit radiation characteristic thereof. The optical detector detects the emitted radiation and generates signals indicative thereof. The signals can be used to determine a presence and absence of one or more of the components in the sample and/or identify the components therein.

Unfortunately, with one such optical detection system, a label attached to a component in the sample emits radiation generally uniformly in all directions about the label, including in directions away from the optical detector. As a consequence, in some instances, less than half of the radiation emitted by the label illuminates the optical detector and is detected thereby. Furthermore, some of the electromagnetic radiation striking the label may penetrate the label rather then being absorbed thereby and inducing radiation emission therefrom. As a result of the above, a higher power excitation source of electromagnetic radiation may have to be used for a given detection power to compensate for detection and label emission inefficiencies. This may result in higher overall cost of the optical detection system. In addition, some labels produce a relatively low power signal, at about a minimum detectable signal level within the existing noise level, even though the excitation light source is at its maximum power level.

### SUMMARY

Aspects of the application address the above matters, and others.

In one aspect, an optical detection system includes an optical element that directs emission radiation, which traverses away from an optical collection path, to the path, wherein the emission radiation is emitted by a radiation sensitive material in a sample under study in response to the material absorbing excitation radiation, and the emission radiation has a spectral characteristic that corresponds to the material.

In another aspect, an optical detection method includes directing emitted radiation traversing away from a radiation collection path to the path, wherein the emitted radiation is emitted by a radiation sensitive material in a sample under study in response to the material absorbing excitation radiation, detecting radiation that includes the emitted radiation directed to the path and emitted radiation traversing the path, and generating a signal indicative of the detected emission radiation.

In another aspect, a sample carrier apparatus includes a sample carrier with at least two opposing sides and configured to carry a sample therebetween. The sample includes one or more radiation sensitive materials that respectively emit radiation having spectral characteristics corresponding to the one or more materials. The apparatus also includes an optical element affixed to a first side of the sample carrier. The optical element is configured to direct radiation emitted by the one or more materials and traversing towards the first side towards an optical collection path.

### BRIEF DESCRIPTION OF THE DRAWINGS

The application is illustrated by way of example and not limitation in the figures of the accompanying drawings, in which like references indicate similar elements and in which:

FIG. 1 illustrates an example optical detection system;

FIG. 2 illustrates example forward emission from a sample in response to the sample absorbing source radiation in a system including a reflector;

FIG. 3 illustrates example backward emission from the sample and reflection thereof by the reflector;

FIG. 4 illustrates example reflected transmission source radiation, producing forward emission and backward emission, which is reflected by the reflector;

FIG. 5 illustrates example forward emission from a sample in response to the sample absorbing source radiation in a system including a filter;

FIG. 6 illustrates example backward emission from the sample and reflection thereof by the filter;

FIG. 7 illustrates example transmission excitation source radiation passing through the filter);

FIG. 8 illustrates an embodiment in which an optical element and a sample carrier are part of a same optical apparatus for the optical detection system.

FIG. 9 illustrates an embodiment in which an optical element and a sample carrier are separate components for the optical detection system.

FIG. 10 illustrates a method.

FIG. 11 illustrates an example optical detection system; and

### DETAILED DESCRIPTION

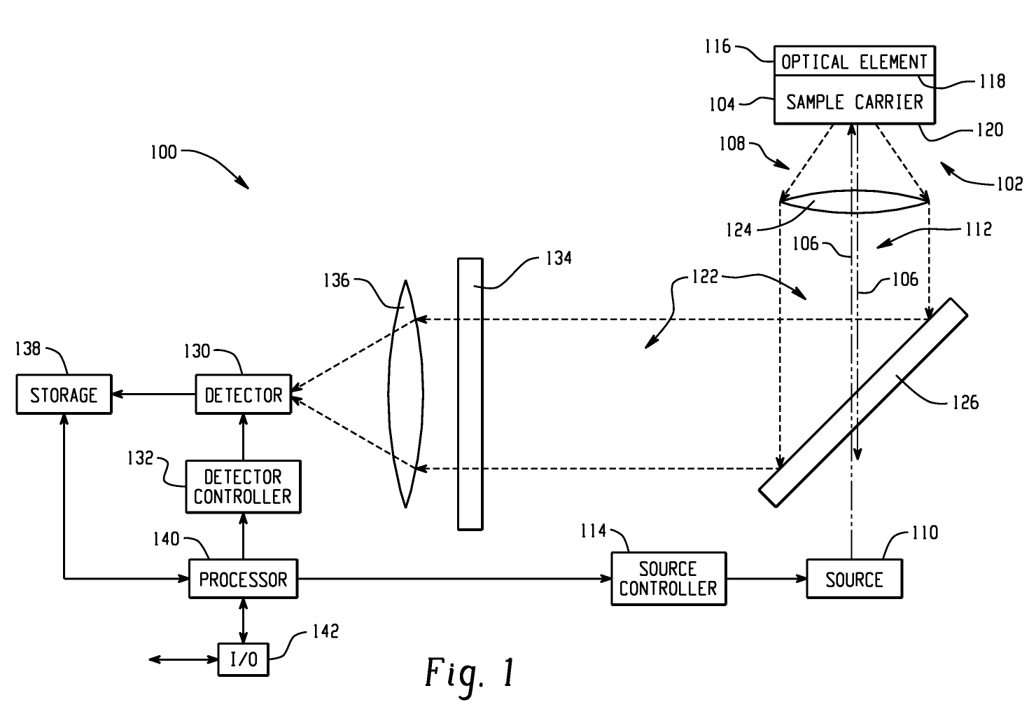

FIG. 1 illustrates an example optical detection system 100. The optical detection system 100 includes a sample carrier support region 102 having one or more structural components for supporting a sample carrier, such as a sample carrier 104, which is configured to carry a sample (not visible in FIG. 1) that includes one or more electromagnetic radiation sensitive materials. Examples of a suitable sample carrier include, but are not limited to, a lab-on-a-chip (LOC), a biochip, and/or other sample carrier. A non-limiting example of a suitable sample includes a bio-sample with one or more strands of human or animal DNA and/or other sample. A non-limiting example of a suitable electromagnetic radiation sensitive material includes a label such as a fluorescent material or other label that selectively attaches to the sample, absorbs incident excitation electromagnetic radiation 106, and emits electromagnetic radiation 108 having spectral characteristics (wavelength range, frequency range, energy range, color range, etc.) that correspond to the particular material absorbing the excitation radiation.

In the context of DNA analysis such as DNA identification and/or sequencing, the electromagnetic radiation sensitive materials may include at least four different fluorescent dyes, each emitting electromagnetic radiation having known but different spectral characteristics. Each dye may target specific, binding to a different one of the four nucleotide bases (adenine (A), guanine (G), cytosine (C), and thymine (T)) in a DNA molecule. In this instance, the electromagnetic radiation emitted by the material(s) in the sample includes electromagnetic radiation having spectral characteristics corresponding to the spectral characteristics of the one or more of the fluorescent dyes attached thereto. One or more additional dyes may be used for calibration and/or other purposes.

An electromagnetic radiation source (source) 110 generates and transmits the excitation electromagnetic radiation 106. The source 110 transmits excitation electromagnetic radiation that traverses a path 112 from the source 110 to the sample carrier support region 102, illuminating the sample and material(s) carried by the sample carrier 104, when the sample carrier 104 is installed therein. The illustrated source 110 is configured to transmit excitation electromagnetic radiation 106 having spectral characteristics within a predetermined range. By way of example, in one instance, the source 110 includes a laser configured to transmit a laser beam having a wavelength of about four hundred and eighty eight nanometers plus or minus five nanometers (488 nm±5 nm). Other sources, including non-laser sources (e.g., a light emitting diode (LED), an incandescent light, etc.), and other electromagnetic radiation wavelength ranges are also contemplated herein.

A source controller 114 controls the electromagnetic radiation source 110. Such control includes, but is not limited to, adjusting the output power, activating the electromagnetic radiation source 110 to transmit the excitation electromagnetic radiation 106 and deactivating an activated electromagnetic radiation source 110 so that the electromagnetic radiation source 110 does not transmit the excitation electromagnetic radiation 106. Other control may include applying a predetermined pulsing pattern, determining emission configuration settings, etc.

An optical element 116 is disposed in connection with a side 118 of the sample carrier 104, which is opposite of a side 120 of the sample carrier 104 that receives the excitation electromagnetic radiation 106. As described in greater detail below, in one instance the optical element 116 reflects electromagnetic radiation, which is emitted by the material(s) in the sample carrier 104 in a direction towards the side 118 and away from a collection path 122, towards the collection path 122. As such, the electromagnetic radiation 108 may include both the electromagnetic radiation emitted by the material(s) in the direction of the collection path 122 and the electromagnetic radiation emitted by the material(s) in a direction away from the collection path 122, which is reflected towards the collection path 122 by the optical element 116. As such, an intensity of the electromagnetic radiation 108 may increase, relative to an embodiment in which the optical element 116 is omitted, while the noise level remains substantially the same.

Also described in greater detail below, depending on the type of optical element, the optical element 116 may additionally reflect the excitation electromagnetic radiation 106 that traverses or penetrates the material, substantially unattenuated, back in a direction towards the sample carrier 104 and hence the sample and material(s). The reflected excitation electromagnetic radiation 106 may interact with the material(s) in a manner substantially similar to the interaction between the excitation electromagnetic radiation 106 and the material(s) described above. As such, the electromagnetic radiation 108 may also include electromagnetic radiation emitted by the material(s) due to the reflected electromagnetic radiation 106. Generally, reflecting the transmission electromagnetic radiation is well suited for applications in which the spectral characteristics of the reflected transmission excitation electromagnetic radiation is substantially similar to the spectral characteristics of the initial incident excitation electromagnetic radiation, such as when a relatively thin (e.g., less than 100 micron, such as 80 micron) sample carrier is employed. The interaction of the reflected transmission radiation may further increase the intensity of the electromagnetic radiation 108, relative to an embodiment in which the optical element 116 is omitted, while the noise level remains substantially the same.

A lens 124 disposed between the sample carrier 104 and the source 110 focuses the excitation radiation 106 at sample carrier and collects the emitted electromagnetic radiation 108 with respect to the collection path 122. The illustrated lens 124 includes a biconvex lens. However, other lenses such as a plano-convex or other lens that suitably focuses the electromagnetic radiation emitted by the material with respect to the target are also contemplated herein.

A filter 126 is disposed between the lens 124 and the source 110. The filter 126 is configured to filter the excitation electromagnetic radiation 106 and to direct the emission electromagnetic radiation 108. With respect to the excitation electromagnetic radiation 106 traversing from the source 110 towards the sample carrier 104, the filter 126 filters the electromagnetic radiation 106 to only pass excitation electromagnetic radiation having predetermined spectral characteristics of interest. Electromagnetic radiation having other spectral characteristics is filtered. With respect to the excitation electromagnetic radiation 106 traversing from the sample carrier 104 to the filter 126, the filter 126 filters the electromagnetic radiation 106 from the collection path 122, for example, by passing the electromagnetic radiation 106. With respect to the emission electromagnetic radiation 108, the filter 126 directs the electromagnetic radiation 108 along the collection path 122, which, in the non-limiting embodiment of FIG. 1, is not straight. An example of a suitable filter includes a dichroic filter, band-pass filter, or other filter that selectively passes electromagnetic radiation based on spectral characteristics while reflecting other electromagnetic radiation based on spectral characteristics.

A detector 130 detects the emission electromagnetic radiation 108 traversing the collection path 122 and generates a signal indicative thereof. In the context of the DNA example discussed herein, detection of the electromagnetic radiation 108 emitted by the material(s) can be used to identify and/or sequence a labeled strand(s) of DNA in a sample carried by the sample carrier 104. For example, detection of electromagnetic radiation having a wavelength corresponding to the wavelength of a particular dye attached to one of the nucleotides can be used to identify the presence of that nucleotide in the sample under study. Detection of electromagnetic radiation having a wavelength other than the wavelength of the particular dye indicates absence of nucleotide in the sample under study. As briefly noted above, other dyes or labels may be used for calibration and/or other purposes.

In another embodiment, the detector 130 includes a plurality of detectors, each configured to detect electromagnetic radiation having different spectral characteristics. By way of example, in the context of the DNA example, one of the detectors may be configured to detect electromagnetic radiation corresponding to a fluorescent dye attached to the nucleotide adenine, another of the plurality of detectors may be configured to detect electromagnetic radiation corresponding to a different fluorescent dye attached to the nucleotide guanine, etc. Likewise, detection of electromagnetic radiation having a wavelength other than the wavelength of the particular dye indicates absence of nucleotide in the sample under study. A detector controller 132 controls the detector 130. Such control includes, but is not limited to, adjusting the gain of detector 130, activating the detector 130 to detect incident electromagnetic radiation and deactivating detection.

A filter 134 is disposed between the filter 126 and the detector 130. The filter 134 is configured to pass the emission electromagnetic radiation 108 traversing the collection path 122 and attenuate and/or reflect other electromagnetic radiation, including any reflected excitation electromagnetic radiation 106 backscattered or otherwise directed in the collection path 122. In another embodiment, the filter 134 is omitted.

A lens 136 is disposed between the filter 134 and the detector 130. The lens 136 focuses the emission electromagnetic radiation 108 incident thereon with respect to the detector 130. Similar to the lens 124, the illustrated lens 136 includes a biconvex lens, but alternatively can include other lenses such as a plano-convex or other lens that suitably focuses the electromagnetic radiation 108 with respect to the detector 130.

A storage component 138 stores various information such as the signal generated by the detector 130, computer readable and/or executable instructions for controlling the source controller 114 and/or the detector controller 132, computer readable and/or executable instructions for processing the signal, the processed signal, computer readable instructions for identifying a nucleotide or other component in a sample based on the signal, and/or other information.

A processor 140 controls the detector controller 132 and the source controller 114 and/or processes the signal generated by the detector, for example, based at least in part on the information in the storage component 138. Although a single processor 140 is shown controlling both the detector controller 132 and the source controller 114, in another embodiment, different processor are used. With such an embodiment, the detector controller 132 and the source controller 114 may be part of the same apparatus or different apparatuses.

Input/output (I/O) 142 allows for interaction with the optical detection system 100 via an entity remote from the optical detection system 100. By way of non-limiting example, the I/O 142 can be used to convey information for display on a monitor or the like, for further processing, etc. In another non-limiting example, the I/O 142 can receive an input signal related to controlling, configuring, etc, the optical detection system 100. Other interaction is also contemplated herein.

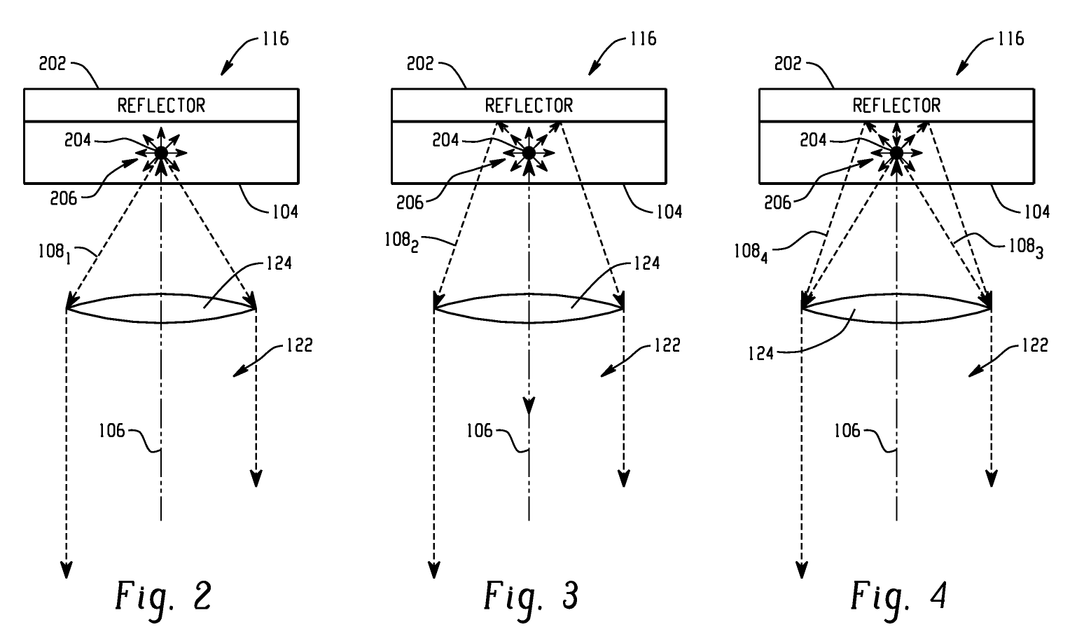

FIGS. 2, 3, and 4 in combination illustrate an embodiment in which the optical element 116 includes a reflector 202 that reflects the emission electromagnetic radiation 108 incident thereon and reflects transmission excitation electromagnetic radiation 106 incident thereon.

Initially referring to FIG. 2, the excitation electromagnetic radiation 106 traverses the lens 124 and illuminates a sample 204 carried by the sample carrier 104. The radiation sensitive material(s) in the sample 204 absorbs at least a sub-portion of the excitation electromagnetic radiation 106 and, in response, emits electromagnetic radiation 206. As shown in FIG. 2, the electromagnetic radiation 206 is emitted substantially uniformly about the sample 204. A sub-portion 108₁ of the electromagnetic radiation 206 traverses the collection path 122 and strikes the lens 124, which focuses the sub-portion 108₁ with respect to the collection path 122.

Turning to FIG. 3, a sub-portion 108₂ of the emission electromagnetic radiation 206 strikes the reflector 202 and is reflected thereby towards the lens 124, which focuses the radiation with respect to the collection path 122. Turning now to FIG. 4, excitation electromagnetic radiation 106 traversing the sample 204 substantially unattenuated and incident on the reflector 202 is reflected thereby back towards the sample 204. At least a sub-portion of the reflected excitation electromagnetic radiation 106 may interact with the material(s) in the sample 204 similar to the interaction described in connection with FIGS. 2 and 3, producing electromagnetic radiation sub-portions 108₃ and 108₄ of the emission electromagnetic radiation 206.

In this example, the sub-portions 108₁, 108₂, 108₃, and 108₄ of the emission electromagnetic radiation 206 combine to form the electromagnetic radiation 108 (FIG. 1). Hence, the intensity of the electromagnetic radiation 108 is based on the sub-portions 108₁, 108₂, 108₃, and 108₄, and may be higher relative to an embodiment in which the reflector 202 is omitted. For example, in one instance, without the reflector 202, the intensity of the electromagnetic radiation 108 is equal to the intensity of 108₁, whereas with the reflector 202, the intensity of the electromagnetic radiation 108 is about four times (400% of) the intensity of 108₁, assuming the sub-portions 108₁, 108₂, 108₃, and 108₄ have substantially equal intensity. In other embodiments, the intensity may be more or less. Alternatively, a lower power (e.g., ¼ power) source of electromagnetic radiation 110 can be used given an intensity of interest equal to less than all of the sub-portions electromagnetic radiation. Alternatively, the intensity can be increased and a lower power source can be used. Using a lower power source of electromagnetic radiation may reduce the cost of the optical detection system 100.

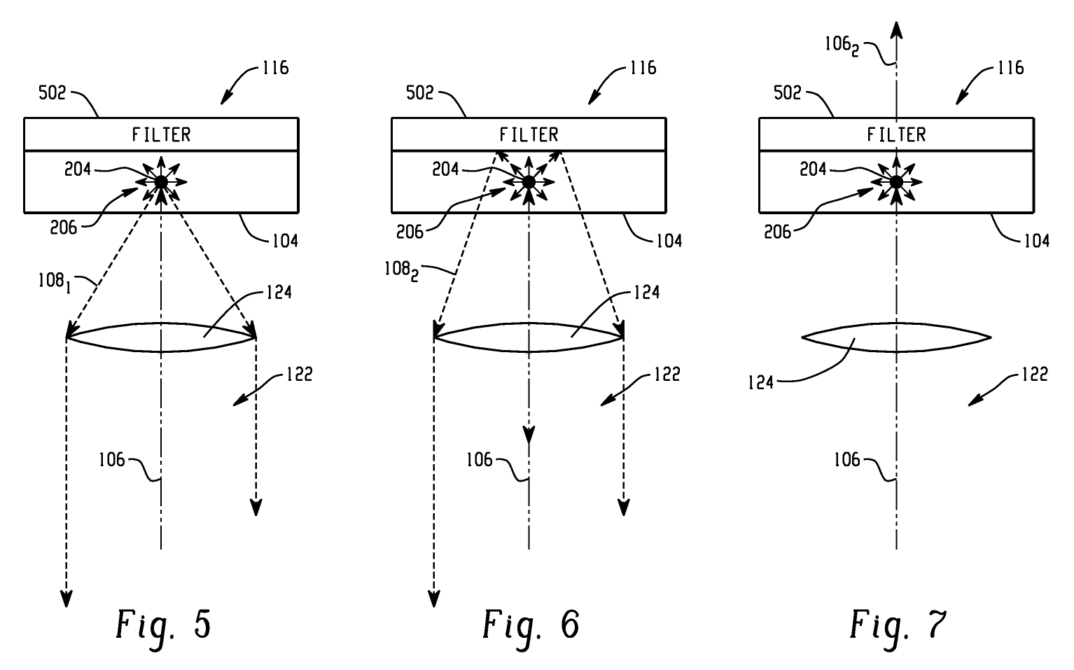

FIGS. 5, 6, and 7 illustrate an embodiment in which the optical element 116 includes a filter 502 that reflects the emission electromagnetic radiation 108 incident thereon and filters or passes transmission excitation electromagnetic radiation 106 incident thereon. FIGS. 5 and 6 are substantially similar to FIGS. 2 and 4, except that the reflector 202 is replaced with the filter 502. In FIG. 7, the excitation electromagnetic radiation 106 traversing the sample 204 passes through the filter 502. With this embodiment and as shown in FIGS. 5-7, the sub-portions 108₁ and 108₂ combine to form the electromagnetic radiation 108 (FIG. 1).

Similar to the embodiment illustrated in FIGS. 2-5, the intensity of the electromagnetic radiation 108 may increase relative to an embodiment in which the optical element 116 is omitted. For example, in one instance, with the filter 502, the intensity of the electromagnetic radiation 108 is about two times (200% of) the intensity of the sub-portion 108₁, assuming the sub-portions 108₁ and 108₂ of the electromagnetic radiation have about equal intensity. In other embodiments, the intensity may be more or less. Alternatively, a lower power (e.g., ½ power) source 110 of excitation electromagnetic radiation can be used given an intensity of interest about equal to the intensity of less than both of the sub-portions of electromagnetic radiation. Alternatively, the intensity can be increased and a lower power source can be used. Likewise, using a lower power source of electromagnetic radiation may also reduce the cost of the optical detection system 100.

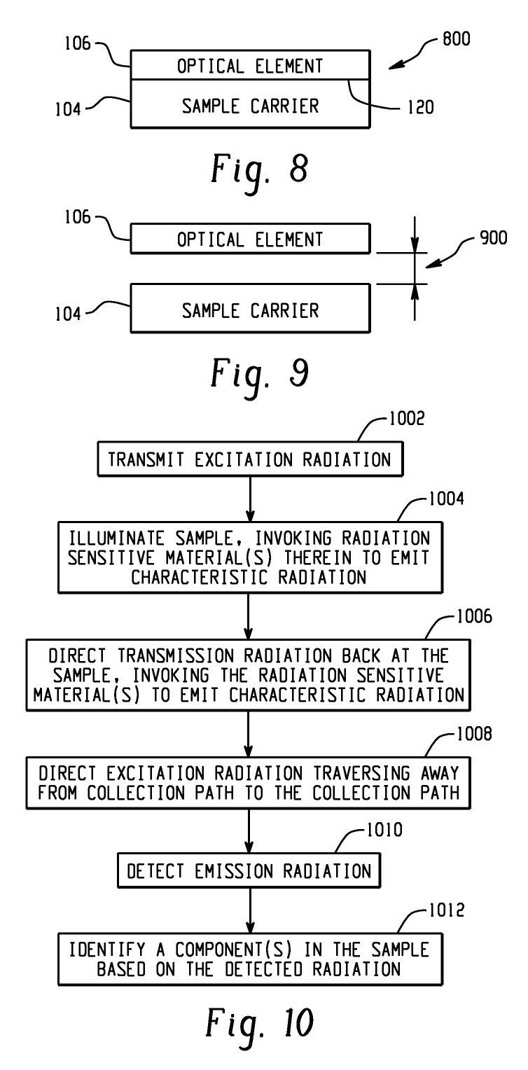

FIGS. 8 and 9 illustrate non-limiting examples of the sample carrier 104 and the optical element 116. Note that the geometry (e.g., size, shape, etc.) of the sample carrier 104 and/or the optical element 116 are for explanatory purposes and not limiting. As such, the sample carrier 104 and/or the optical element 116 may have other geometry.

In FIG. 8, a sample carrier apparatus 800 includes the sample carrier 104 with the optical element 116 attached thereto. In one instance, the optical element 116 includes a one or more layers such as a coating or other layer having reflection or transmission properties of interest. Such a coating may include one or more thin layers of metals, such as aluminum, silver, gold, or other metal with suitable reflective properties. Such a coating may be applied so that the optical element 116 has a thickness and/or density corresponding to a degree of reflection or transmission of interest.

Additionally or alternatively, the optical element 116 may include a coating of one or more layers of a dielectric having a refractive index mismatch with the sample carrier corresponding to reflection or transmission properties of interest. The thickness and/or number of layers can be predetermined to tailor the reflectivity and transmitivity of the coating. Where both a metal based and dielectric coating are applied, the dielectric may be applied to provide a protective for the metal based coating.

Such a coating(s) may be applied to produce from about 0.01% to about 100% reflectivity for electromagnetic radiation having particular spectral characteristics. The coating(s) may have similar or different reflectivity for electromagnetic radiation having different spectral characteristics.

The optical element 116 can be variously attached to the sample carrier 104. For example, in one instance the optical element 116 includes a paint or the like that is painted on the side 120 of the sample carrier 104. In another instance, the optical element 116 includes a thin film, foil, or the like that affixed to the side 118, 120 of the sample carrier via an adhesive or the like. Other suitable techniques that can be used to attach the optical element 116 to the sample carrier 104 include, but are not limited to, vacuum deposition, spin coating, sputter deposition, platting, lamination, and/or other techniques.

In FIG. 9, the optical element 116 and the sample carrier 104 are separate components, separated by a distance 900. In one embodiment, the distance 900 is such that the optical element 116 and the sample carrier 104 are in physical contact. In another embodiment, the distance 900 is such that the optical element 116 and the sample carrier 104 are not in physical contact. With the latter embodiment, the optical element 116 and the sample carrier 104 are separated by an air gap having a non-zero width. Similar to the embodiment of FIG. 8, the optical element 116 may be a reflector or a filter. Alternatively, the optical element 116 may include a substrate coated as discussed in connection with FIG. 8 and/or otherwise.

Other configurations of the optical detection system are also contemplated herein. For example, FIG. 11 illustrates an embodiment in which the source 110 transmits excitation electromagnetic radiation that traverses the optical element 116 and then strikes the sample carried by the sample carrier 104. Similar to FIGS. 5-7, with this embodiment, the optical element 116 includes the filter 502, which passes the excitation electromagnetic radiation 106 and reflects the emission electromagnetic radiation 108 incident thereon towards the collection path 122. The other components behave as described herein. Other embodiments are also contemplated herein.

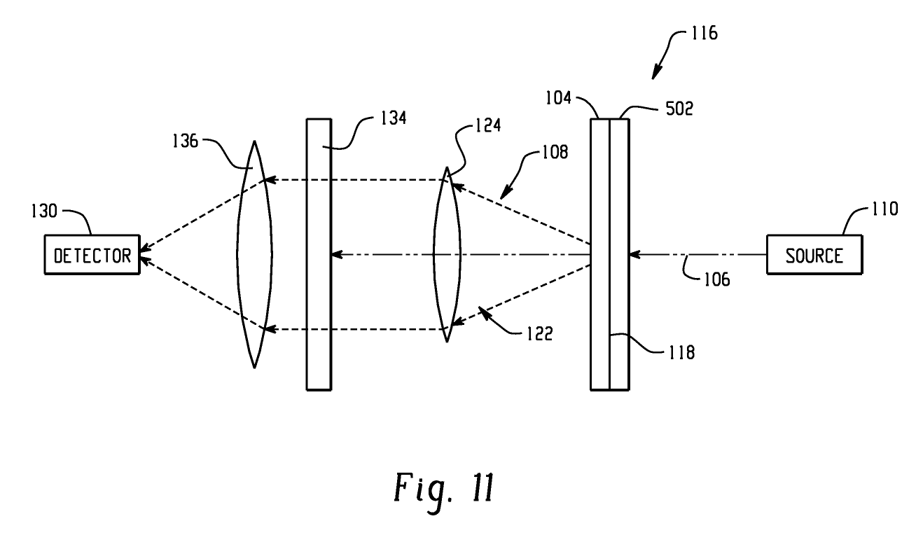

FIG. 10 illustrates a method of optical detection.

At 1002, a source of excitation radiation is activated. As described herein, the excitation radiation is directed at a sample carrier 104 carrying a sample of interest, such as a strand of DNA labeled with a fluorescent dye.

At 1004, the excitation radiation illuminates the sample and label, and the label absorbs the excitation radiation and emits electromagnetic radiation respectively having different known spectral characteristics. As described herein, multiple labels, with different spectral characteristics, that bind to different components in the sample can be employed.

At 1006, the excitation radiation traversing the sample is directed back at the sample, invoking emission from the one or more labels. Alternatively, the excitation radiation traversing the sample and labels is filtered.

At 1008, emitted electromagnetic radiation traversing away from a collection path is reflected to the collection path.

At 1010, both emitted electromagnetic radiation traversing the collection path and the reflected emission electromagnetic radiation traversing the collection path are detected.

At 1012, the detected electromagnetic radiation is used to identify the label and hence the component in the sample.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. An optical detection system, comprising:
an optical element that directs emission radiation, which traverses away from an optical collection path, to the path, wherein the emission radiation is emitted by a radiation sensitive material in a sample under study in response to the material absorbing excitation radiation, and the emission radiation has a spectral characteristic that corresponds to the material.

2. The system of claim 1, wherein the optical element re-directs transmission excitation radiation traversing the sample back towards the sample.

3. The system of claim 2, wherein the excitation radiation and the transmission excitation radiation have substantially similar spectral characteristics.

4. The system of claim 2, wherein the optical element emits second emission radiation, which traverses away from the path, to the path, wherein the second emission radiation is emitted by the radiation sensitive material in response to the material absorbing the re-directed transmission excitation radiation.

5. The system of claim 4, wherein the emission radiation and the second emission radiation have substantially similar spectral characteristics.

6. The system of claim 1, wherein the optical element filters transmission excitation radiation traversing the sample.

7. The system of claim 1, further comprising: a sample carrier support region that supports a sample carrier carrying the sample, wherein the optical element is attached to the sample carrier.

8. The system of claim 7, wherein the optical element is one of a coating, a layer, or film attached to the sample carrier.

9. The system of claim 1, further comprising: a sample carrier support region that supports a sample carrier carrying the sample, wherein the optical element and the sample carrier are separate components.

10. The system of claim 1, further comprising: a detector that detects the emission radiation and generates a signal indicative of the spectral characteristic.

11. The system of claim 10, wherein the material is bound to a target in the sample, and further comprising: a processor that identifies the target in the sample based on the signal.

12. The system of claim 1, wherein the sample includes a plurality of different radiation sensitive materials attached to different radiation sensitive materials in the sample, and each material emits radiation having a unique spectral characteristic.

13. The system of claim 12, wherein the sample includes a DNA molecule, the materials include different radiation sensitive labels, each of the labels attaches to a different one of the nucleotide bases of the DNA, and the signal is used to identify one or more nucleotide bases of a DNA strand in the sample.

14. An optical detection method, comprising:
directing emitted radiation traversing away from a radiation collection path to the path, wherein the emitted radiation is emitted by a radiation sensitive material in a sample under study in response to the material absorbing excitation radiation;
detecting radiation that includes the emitted radiation directed to the path and emitted radiation traversing the path; and
generating a signal indicative of the detected emission radiation.

15. The method of claim 14, wherein an intensity of the detected radiation is based on an intensity of the detected emitted radiation directed to the path and an intensity of the detected emitted radiation traversing the path.

16. The method of claim 14, further comprising:
directing transmission excitation radiation traversing the material back at the material, wherein the radiation sensitive material emits second radiation in response to absorbing the directed transmission excitation radiation.

17. The method of claim 16, wherein the detected radiation further includes radiation emitted in response to the material absorbing the directed transmission excitation radiation.

18. The method of claim 17, wherein the intensity of the detected radiation is further based on an intensity of the radiation emitted in response to the absorption of the directed transmission excitation radiation.

19. The method of claim 14, wherein the emitted radiation has spectral characteristics corresponding to the material, and further comprising: identifying the material based on the detected radiation.

20. A sample carrier apparatus for carrying a sample under study in an optical detection system, the sample carrier apparatus, comprising:
a sample carrier including at least two opposing sides and configured to carry a sample therebetween, wherein the sample includes one or more radiation sensitive materials that respectively emit radiation having spectral characteristics corresponding to the one or more materials; and
an optical element affixed to a first of the sides of the sample carrier, wherein the optical element is configured to direct radiation emitted by the one or more materials and traversing the first side to an optical collection path.

21. The sample carrier apparatus of claim 20, wherein the optical element is configured to direct excitation radiation traversing the one or more materials back towards the one or more materials.

22. The sample carrier apparatus of claim 21, wherein the excitation radiation directed back towards the one or more materials is absorbed by the one or more materials, which, in response thereto, emits second radiation having spectral characteristics corresponding to the one or more materials.

23. The sample carrier apparatus of claim 21, wherein the sample carrier has a thickness of less than 100 microns.

24. The sample carrier apparatus of claim 20, wherein the optical element includes a reflector that reflects radiation emitted by the one or more materials and excitation radiation.

25. The sample carrier apparatus of claim 20, wherein the optical element includes a filter that reflects radiation emitted by the one or more materials and filters excitation radiation.

26. The sample carrier apparatus of claim 20, wherein the optical element includes a film with predetermined reflectivity and/or transmitivity properties of interest.

27. The sample carrier apparatus of claim 20, wherein the optical element includes an optical paint.

28. The sample carrier apparatus of claim 20, wherein the optical element includes a foil with predetermined reflectivity and/or transmitivity properties of interest.
